(19) United States
(12) Patent Application Publication
(10) Pub. No.: US 2006/0191752 A1
(43) Pub. Date: Aug. 31, 2006

(54) Axle assembly of driven wheel

(76) Inventor: Hyung Joo Lee, Gyeongju-si (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,118

(22) Filed: Sep. 14, 2005

(30) Foreign Application Priority Data
Feb. 28, 2005 (KR) 10-2005-16534

(51) Int. Cl. B60T 1/06

(52) U.S. Cl. 188/18 A; 188/218 XL

(57) ABSTRACT

An axle assembly of a driven wheel of the present invention removes a hub and a wheel bearing assembly further includes a bearing inner race shaft in order to integrate the hub and a brake disc. Since the bearing inner race shaft is constructed to process a tab in its inside and combine the brake disc integral type hub with a bolt, thereby adding a shaft force to a wheel bearing, its structure is simple and its weight reduces. Also, since an assembly process is simple, and an assembly operation time becomes shortened, cost may be saved.

### BACKGROUND OF THE INVENTION

1. Field of Invention

The present invention relates to an axle assembly of a driven wheel, and more particularly, to an axle assembly of a driven wheel provided with a disc brake integral type hub in which a hub is removed and a wheel bearing is integrated with a brake disc.

2. Description of the Prior Art

Generally, an axle of a vehicle is a portion supporting the weight of the vehicle through a wheel attached thereto, and divided into a driving wheel axle delivering a driving force generated at an engine and a driven wheel axle not delivering the driving force.

Furthermore, according to a suspension manner, the axle of the vehicle is divided into an integral type axle combining left and right wheels with one axle and a separate type axle enabling the left and the right wheels to work respectively separately. The driving wheel axle serves to deliver a driving force passed through a transmission and a differential gear from an engine to wheels, and to support the strengths of up and down and left and right directions coming from the road surface, and the front and the rear directions. A front axle of a front-wheel driving vehicle or a rear axle of a rear-wheel driving vehicle corresponds thereto.

The axle is connected to a wheel through a hub, and an end portion of the hub is covered with a cover to prevent dust or foreign body from incoming and prevent an internal lubrication oil from leaking.

In the meantime, a disc brake of a vehicle is constructed to brake by pressing a brake pad with an oil pressure on both sides of a brake disc rotating with wheels. The disc brake comprises a brake disc made of special cast iron and rotating with being connected to a hub, a caliper made of special cast iron and shaped into a saddle, a couple of brake cylinders combined in the left and right sides of the caliper, a piston, and a pad mounted to the piston and generating a driving force by friction with the brake disc.

As illustrated in FIG. 1, a conventional axle assembly comprises a hub assembly 10, a brake disc 20, a wheel bearing assembly 30, and a knuckle 40.

The hub assembly 10 comprises a hub 12 and a hub bolt 14. The wheel bearing assembly 30 comprises a bearing 32, an inner race 34, an outer race 36, and a bearing connecting bolt 38.

A hub flange 16 of the hub assembly 10 is combined with the brake disc 20 and a wheel (not illustrated) to the outside of a vehicle by the hub bolt 14, and coupled with the wheel bearing assembly 30 to the inside of the vehicle, thereby being coupled with other suspension (not illustrated) parts, such as the knuckle 40.

While driving of the vehicle, wheels, the brake disc 20, and the hub 12 rotate, and the bearing 32 mounted to the fixed knuckle 40 serves to support the load of the vehicle and makes rotation smooth.

Meanwhile, the brake disc 20 is connected by using the hub bolt 14 to be fixed to the hub flange 16 of the hub 12. Also, said brake disc 20 and the brake disc 20 assembled to the knuckle 40 constitute brake apparatus of the vehicle, and serve to stop the vehicle by the friction resistance between a brake pad (not illustrated) and a disc (not illustrated).

Since the conventional axle assembly constructed such above processes the brake disc and a wheel loaded surface on a hub section, there is a disadvantage that cost goes up, assembly man-hours also increase and design freedom gets lowered.

Furthermore, since the management of the axial flow shake of the hub and the brake disc is required to secure the stable brake capacity, there is a problem that the management of general shake is difficult because of the shake accumulated between parts.

In addition, there is a disadvantage that the management of general shake is difficult since a tap hole process for assembly of the brake disc is added, and cost goes up since a process time increases due to addition of process man hours and assembly.

### SUMMARY OF THE INVENTION

The present invention is conceived to solve the above problems. Thus, an object of the present invention is to provide an axle assembly of a driven wheel provided with a brake disc integral type hub in which a hub of an axle assembly for vehicle is removed and a brake disc is integrated with a wheel bearing.

Other object of the present invention is to provide an axle assembly of a driven wheel which can simplify the structure of an axle assembly, thereby reducing its weight and saving its cost.

To accomplish the above object of the present invention, according to an aspect of the present invention, there is provided an axle assembly of a driven wheel comprising: a hub; a brake disc connected to the hub; a wheel bearing assembly comprising a bearing, an inner race and an outer race formed inside and outside of the bearing, and a bolt connecting the bearing to a knuckle; and a knuckle connected to the wheel bearing assembly; wherein a brake disc integral type hub removing a hub is provided to integrate the brake disc and the hub; the wheel bearing assembly further comprises a bearing inner race shaft, and the bearing inner race shaft process a tap in its inside; and the brake disc integral type hub is constructed to be combined by a bolt and give a shaft force to a wheel bearing, thereby giving pre-pressure.

In the axle assembly, a protrude portion is formed on one end of the brake disc integral type hub, and one portion of the protrude portion is provided to be opposite to the inner race of the wheel bearing assembly, and a lower portion of the protrude portion is provided to be opposite to a smooth portion. The brake disc integral type hub is coupled with the bolt by inserting a washer. Also, an inter-contacting portion of the brake disc integral type hub is processed to be any one of non-circle, a polygon, and a spline, so as to prevent inter-skidding.

In the axle assembly, a protrusion portion is formed on one end of the bearing inner race shaft, and a smooth portion is formed on the other end thereof, and the protrusion portion is bent to the outside of the bearing.

According to another aspect of the present invention, there is provided an axle assembly of a driven wheel comprising: a hub; a brake disc connected to the hub; a wheel bearing assembly comprising a bearing, an inner race and an outer race formed inside and outside of the bearing, and a bolt connecting the bearing to a knuckle; and a knuckle connected to the wheel bearing assembly; wherein a hub is removed to integrate the brake disc and the hub, the wheel bearing assembly further comprises a bearing inner race shaft, and a portion of the bearing inner race shaft is combined with a brake disc integral type hub by forming.

In the axle assembly, it is preferable that a caulking portion is formed on an end of the bearing inner race shaft. The forming is completed by forming or swaging. Also, an inter-contacting portion of the brake disc integral type hub is processed to be any one of non-circle, a polygon, and a spline, so as to prevent inter-skidding.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a sectional view of an assembly of a brake disc and a wheel bearing according to the prior art;

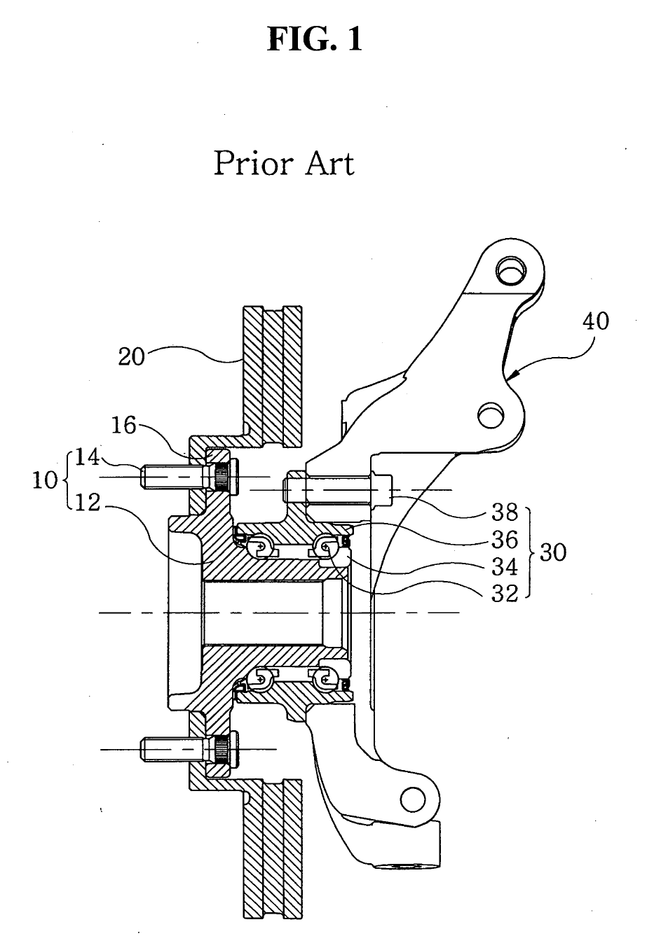

FIG. 2 is a sectional view of an axle assembly of a driven wheel according to an embodiment of the present invention;

FIG. 3 is a sectional view of an assembly of a driven wheel according to other embodiment of the present invention; and

FIG. 4 is a front sectional view of the axle assembly of FIG. 3.

### DETAILED DESCRIPTION OF THE PREFERRED EMBODIMENT

An embodiment of an axle assembly of a driven wheel of the present invention will be in detail described with reference to the accompanying drawings.

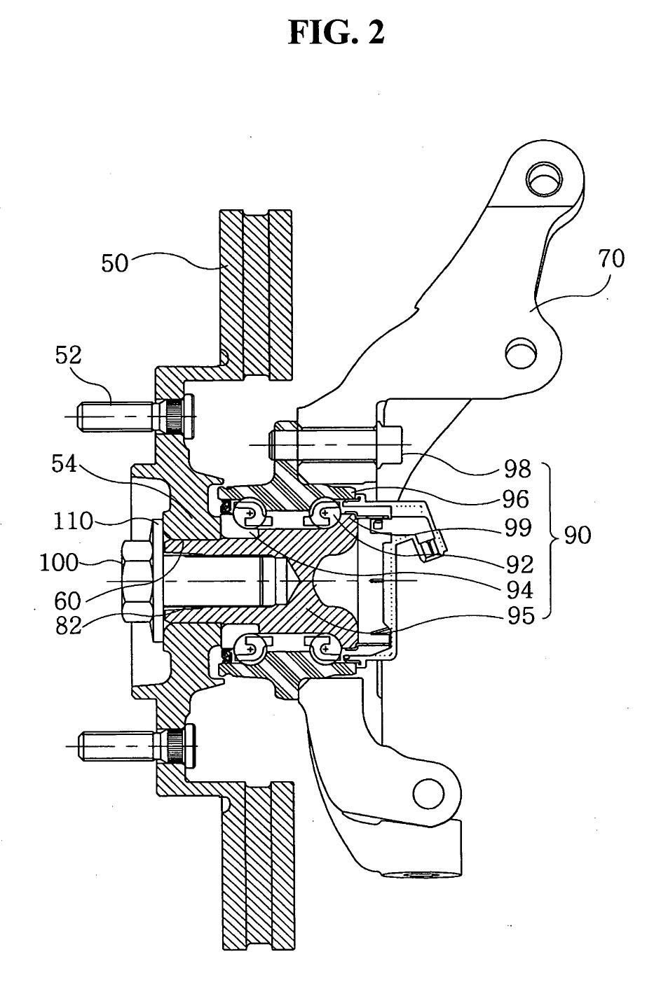

FIG. 2 is a sectional view of an axle assembly of a driven wheel according to an embodiment of the present invention. As illustrated in FIG. 2, the axle assembly of the driven wheel of the present invention comprises a brake disc integral type hub 50, a wheel bearing assembly 90, and a knuckle 70.

A protrude portion 54 is formed on one end of the brake disc integral type hub 50. One portion of the protrude portion 54 is provided to be opposite to an inner race 94 of the wheel bearing assembly 90, and a lower portion of the protrude portion 54 is provided to be opposite to a smooth portion 60. A reference symbol 52 is a hub bolt.

In the meantime, a conventional hub is removed to integrate a brake disc and the hub, and the wheel bearing assembly 90 comprises a bearing 92, an inner race 94, a bearing inner race shaft 95, an outer race 96, and a bearing connecting bolt 98. A protrusion portion 99 is formed on one end of the bearing inner race shaft 95, and the smooth portion is formed on the other end thereof. The protrusion portion 99 is bent to the outside of the bearing 92.

After a tap 82 is formed inside of the bearing inner race housing 95 and the brake disc integral type hub 50 is assembled, a washer 110 is inserted and fastened by an assembly bolt 100, thereby giving a shaft force to the wheel bearing assembly 90 and giving pre-pressure.

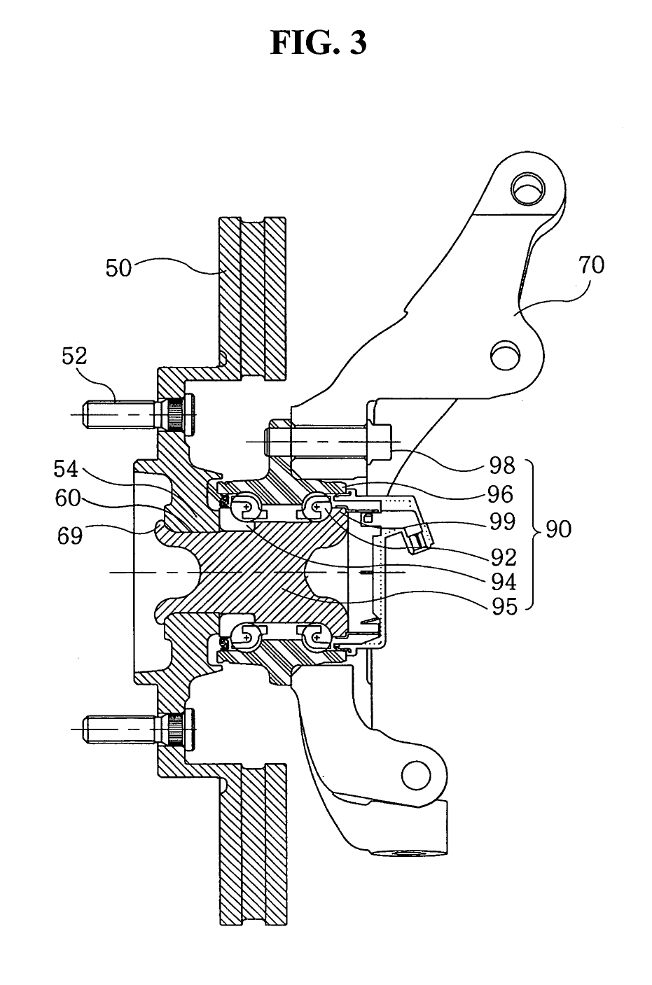

FIG. 3 is a sectional view of an axle assembly of a driven wheel according to other embodiment of the present invention. As illustrated in FIG. 3, the axle assembly of the driven wheel of the present invention has the same configuration of the brake disc integral type hub 50 and the knuckle 70 to configuration of the aforementioned embodiment. Only difference is configuration of the wheel bearing assembly 90.

While the smooth portion 60 is formed on one end of the bearing inner race shaft 95 of the wheel bearing assembly 90 as the aforementioned embodiment, a caulking portion 69 is formed, which is unlike the aforementioned embodiment. The caulking portion 69 is bent to the outside of the bearing inner race shaft 95.

The caulking portion 69 is formed by forming, swaging, or caulking, in a state where the protrude portion 54 of the brake disc integral type hub 50 is inserted.

Like above, when the brake disc integral type hub 50 is applied, a vehicle axle assembly becomes simplified. Thereby, not only the number of parts but also weight and cost may be reduced.

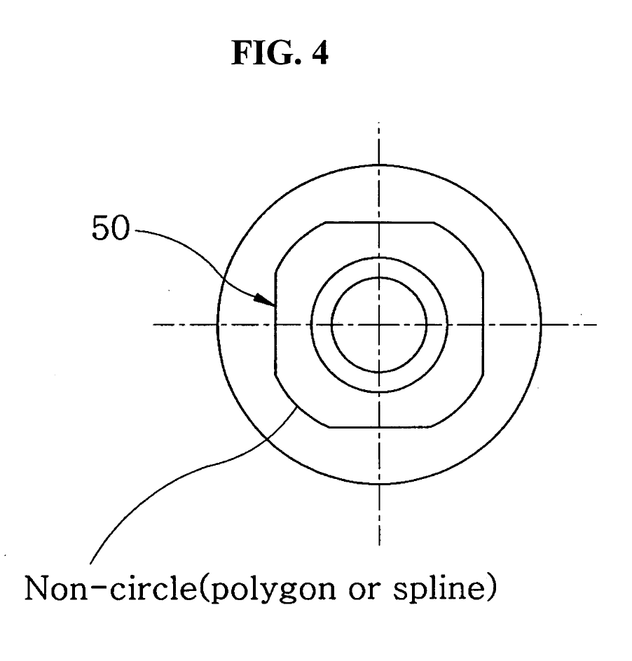

As illustrated in FIG. 4, a portion of the brake disc integral type hub 50 contacting with the wheel bearing assembly 90 each other is processed to be non-circular, so as to prevent inter-skidding in the direction of the circumference of a circle with the wheel bearing assembly 90. After being processed to be non-circular, the brake disc integral type hub 50 is coupled with the bearing inner race shaft 95 by giving a shaft force of an axial flow to the bearing 92 and giving pre-pressure thereof.

As described above, since an axle assembly of a driven wheel of the present invention removes a hub and integrates a wheel bearing and a brake disc, its structure becomes simplified and its weight also reduces. In addition, an assembly operation time gets shortened and cost may be saved since an assembly process becomes simplified.

Furthermore, since the axle assembly of the driven wheel of the present invention enhances design freedom of a wheel bearing assembly, its durability life span may increase. Also, since it is possible to manage the axial flow shake of the axle assembly easily, the brake capacity may be secured.

What is claimed is:

1. An axle assembly of a driven wheel comprising:
a hub;
a brake disc connected to the hub;
a wheel bearing assembly comprising a bearing, an inner race and an outer race formed inside and outside of the bearing, and a bolt connecting the bearing to a knuckle; and
a knuckle connected to the wheel bearing assembly;
wherein a brake disc integral type hub removing a hub is provided to integrate the brake disc and the hub;
the wheel bearing assembly further comprises a bearing inner race shaft, and the bearing inner race shaft process a tap in its inside; and
the brake disc integral type hub is constructed to be combined by a bolt and give a shaft force to a wheel bearing, thereby giving pre-pressure.

2. The axle of assembly of claim 1, wherein a protrude portion is formed on one end of the brake disc integral type hub, and one portion of the protrude portion is provided to be opposite to the inner race of the wheel bearing assembly, and a lower portion of the protrude portion is provided to be opposite to a smooth portion.

3. The axle of assembly of claim 1, wherein the brake disc integral type hub is coupled with the bolt by inserting a washer.

4. The axle of assembly of claim 2, wherein the brake disc integral type hub is coupled with the bolt by inserting a washer.

5. The axle of assembly of claim 1, wherein an inter-contacting portion of the brake disc integral type hub is processed to be any one of non-circle, a polygon, and a spline, so as to prevent inter-skidding.

6. The axle assembly of claim 1, wherein a protrusion portion is formed on one end of the bearing inner race shaft, and a smooth portion is formed on the other end thereof, and the protrusion portion is bent to the outside of the bearing.

7. An axle assembly of a driven wheel comprising:
a hub;
a brake disc connected to the hub;
a wheel bearing assembly comprising a bearing, an inner race and an outer race formed inside and outside of the bearing, and a bolt connecting the bearing to a knuckle; and
a knuckle connected to the wheel bearing assembly;
wherein a hub is removed to integrate the brake disc and the hub, the wheel bearing assembly further comprises a bearing inner race shaft, and a portion of the bearing inner race shaft is combined with a brake disc integral type hub by forming.

8. The axle assembly of claim 7, wherein a caulking portion is formed on an end of the bearing inner race shaft.

9. The axle assembly of claim 7, wherein the forming is completed by forming or swaging.

10. The axle assembly of claim 7, wherein an inter-contacting portion of the brake disc integral type hub is processed to be any one of non-circle, a polygon, and a spline, so as to prevent inter-skidding.
